(19) United States
(12) Patent Application Publication
(10) Pub. No.: US 2007/0223668 A1
(43) Pub. Date: Sep. 27, 2007

(54) INSERTING CONTENT INTO A CONNECTION USING AN INTERMEDIARY

(75) Inventors: Steven Blumenfeld, Lafayette, CA (US); Geoffrey Smith, Mountain View, CA (US); Pierre Couture, San Francisco, CA (US); John Kern, Menlo Park, CA (US); Mark McCabe, Point Richmond, CA (US); Jeffrey Malkin, San Francisco, CA (US); Thomas Pepper, Boulder Creek, CA (US)

Correspondence Address: FISH & RICHARDSON P.C., P.O. BOX 1022, MINNEAPOLIS, MN, 55440-1022, US

(73) Assignee: Phonebites, Inc.

(21) Appl. No.: 11/673,967

(22) Filed: Feb. 12, 2007

Related U.S. Application Data
(60) Provisional application No. 60/771,886, filed on Feb. 10, 2006.

(51) Int. Cl. H04M 3/42

(52) U.S. Cl. 379/201.01

(57) ABSTRACT

Inserting audio content into one or more communications channels includes associating audio content with one or more corresponding triggers. A communications channel is established with an initiating device and a host, and a communications channel is established with a recipient device and the host. Voice communications are enabled to be exchanged, through the host, between the initiating device and the recipient device. A dual tone multi-frequency (DTMF) indicative of a pressed key on the device keypad is received from the initiating device. The audio content associated with the received IDTMF is identified based on the associated audio content with one or more corresponding triggers. The audio content identified as associated with the received DTMF is accessed. The accessed audio content is inserted in the communications channel with the initiating device and the host and the communications channel with the recipient device and the host.

### CROSS-REFERENCE TO RELATED APPLICATIONS

This application claims priority to U.S. Provisional Application No. 60/771,886, entitled “Inserting Content into a Connection Using an Intermediary,” and filed Feb. 10, 2006. This application is incorporated by reference.

### TECHNICAL FIELD

This document relates to exchanging communications.

### BACKGROUND

Communications may be used to deliver information to individuals. For example, a person may call a friend using fixed or wireless phones.

### SUMMARY

According to one general implementation, a method of inserting audio content into one or more communications channels includes associating audio content with one or more corresponding triggers. A communications channel is established with an initiating device and a host, and a communications channel is established with a recipient device and the host. Voice communications are enabled to be exchanged, through the host, between the initiating device and the recipient device. A dual tone multi-frequency (DTMF) indicative of a pressed key on the device keypad is received from the initiating device. The audio content associated with the received DTMF is identified based on the associated audio content with one or more corresponding triggers. The audio content identified as associated with the received DTMF is accessed. The accessed audio content is inserted in the communications channel with the initiating device and the host and the communications channel with the recipient device and the host.

Implementations may include one or more of the following features. For example, establishing the communications channel with the initiating device and the host may include initiating a telephone call from a user associated with the initiating device to the host and/or establishing the communications channel with the recipient device and the host may include initiating a telephone call from a user associated with the recipient device to the host. Associating audio content with one or more corresponding triggers may include receiving configuration input over the Internet. The communications channel with the initiating device and the host and the communications channel with the recipient device and the host may be the same communications channel.

Call configuration options may be received over the Internet. The received configuration options may be associated with either a user identity or a calling device. The configuration options may be stored, and the configuration options may be accessed in response to a phone call from either the user identity or the calling device. Receiving call configuration options may include receiving an indication of specific audio content to be associated or an indication of specific triggers audio content is to be associated with.

In the method, a further DTMF indicative of a pressed key on the device keypad may be received from the recipient device. The audio content associated with the received further DTMF may be identified based on the associated audio content with one or more corresponding triggers. Further audio content identified as associated with the received further DTMF may be accessed. The accessed further audio content may be inserted in the communications channel with the initiating device and the host and the communications channel with the recipient device and the host.

Also, in the method, a different DTMF indicative of a pressed key on the device keypad may be received from the initiating device. That the received DTMF is associated with altering which audio content is associated with the corresponding triggers may be identified. Which audio content is associated with the corresponding triggers may be altered. The audio content identified as associated with the received DTMF may be accessed. The first DTMF may again be received from the initiating device. Different audio content associated with the first DTMF may be identified based on the associated audio content with one or more corresponding triggers. The different audio content identified as associated with the received DTMF may be accessed. The accessed different audio content may be inserted in the communications channel with the initiating device and the host and the communications channel with the recipient device and the host.

Further, in the method a different DTMF indicative of a pressed key on the device keypad may be received from the initiating device. That the received DTMF is associated with altering whether audio content is inserted or DTMF is passed may be identified. Whether audio content is inserted may be altered so that DTMF is passed. The first DTMF may again be received from the initiating device. The first DTMF may be passed to the recipient device. Passing the first DTMF to the recipient device may include reproducing the first DTMF.

According to another general implementation, a method of inserting audio content into one or more communications channels includes associating audio content with one or more corresponding triggers. A communications channel is established with an initiating device and a host, and a communications channel is established with a recipient device and the host. Voice communications are enabled to be exchanged, through the host, between the initiating device and the recipient device. A short message service message (SMS) including a trigger to insert audio content is received from the initiating device. The audio content associated with the received trigger is identified based on the associated audio content with one or more corresponding triggers. The audio content identified as associated with the received trigger is accessed. The accessed audio content is inserted in the communications channel with the initiating device and the host and the communications channel with the recipient device and the host.

Implementations may include one or more of the following features. For example, receiving an SMS may include receiving a multimedia message service message. Also, call configuration options may be received with an SMS message. The received configuration options may be associated with either a user identity or a calling device. The configuration options may be stored, and the configuration options may be accessed in response to a phone call from either the user identity or the calling device. Receiving call configuration options may include receiving an indication of specific audio content to be associated or an indication of specific triggers audio content is to be associated with.

According to a further general implementation, a method of inserting audio content into one or more communications channels includes associating audio content with one or more corresponding triggers. A communications channel is established with an initiating device and a host, and a communications channel is established with a recipient device and the host. Voice communications are enabled to be exchanged, through the host, between the initiating device and the recipient device. Instructions including a trigger to insert audio content are received from the initiating device. The audio content associated with the received trigger is identified based on the associated audio content with one or more corresponding triggers. The audio content identified as associated with the received trigger is accessed. The accessed audio content is inserted in the communications channel with the initiating device and the host and the communications channel with the recipient device and the host. Receiving an SMS may include receiving a multimedia message service message.

Implementations may include one or more of the following features. For example, call configuration options may be received with data packets. Receiving instructions including a trigger may include receiving data packets including a trigger. Receiving data packets may include receiving Internet Protocol based data packets including a trigger, data packets intermixing voice and trigger data, or an SMS message. Receiving data packets may include receiving separate data packets including voice data separately from data packets including trigger data.

Also, associating audio content may include associating audio content modification with one or more corresponding triggers. Receiving instructions including a trigger to insert audio content may include receiving instructions including a trigger to modify audio content from the initiating device. Identifying the audio content associated with the received trigger may include identifying the audio content modification associated with the received trigger based on the associated audio content modification with one or more corresponding triggers. Accessing the audio content may include modifying communication with the identified audio content modification. Inserting the accessed audio content in the communications channel may include inserting the modified communication in the communications channel with the initiating device and the host and the communications channel with the recipient device and the host.

Further, associating audio content may include associating audio content with one or more corresponding voice triggers. Receiving instructions including a trigger to insert audio content may include receiving a voice trigger to insert audio content from the initiating device. Identifying the audio content associated with the received trigger may include identifying the audio content associated with the received voice trigger based on the associated audio content with one or more corresponding voice triggers. Accessing the audio content may include accessing the audio content identified as associated with the received voice trigger.

Implementation may also include systems employing similar features.

### DESCRIPTION OF DRAWINGS

FIGS. 1-2C illustrate exemplary communication systems configured to insert content into a communication channel with a host.

FIG. 3 is a flow chart of an exemplary process by which content is inserted into a communication channel with a host.

FIG. 4A is a flow chart of an exemplary process by which audio content is inserted into a communication channel established by calling an audio content insertion gateway.

FIG. 4B is a flow chart of an exemplary process by which audio content is inserted into a communication channel established by calling a phone number with an additional prefix.

FIG. 5 is a flow chart of an exemplary process employing indirect use of dual tone multi-frequency signals.

FIG. 6 is a flow chart of an exemplary process by which audio content is inserted into a wireless communication channel established by software on a wireless phone.

FIG. 7A illustrates an exemplary graphical user interface on a wireless telephone to select content profiles for insertion.

FIG. 7B illustrates an exemplary graphical user interface on a wireless telephone to select audio content for insertion.

FIG. 8 is a flow chart of an exemplary process by which audio content is inserted into a communication channel using a device.

FIG. 9 illustrates an exemplary graphical user interface shown on two wireless telephones that are dueling.

FIG. 10 illustrates an exemplary graphical user interface on a website enabling a user to select audio content predicated upon simultaneously placement of advertisements.

FIG. 11A is a flow chart of an exemplary process by which content is inserted into a communication channel with a host.

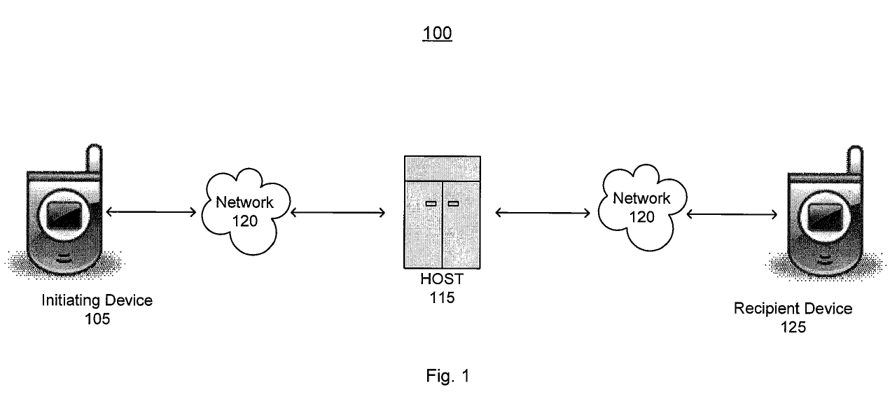

FIG. 1B is a flow chart of an exemplary process by which communication through a host is modified.

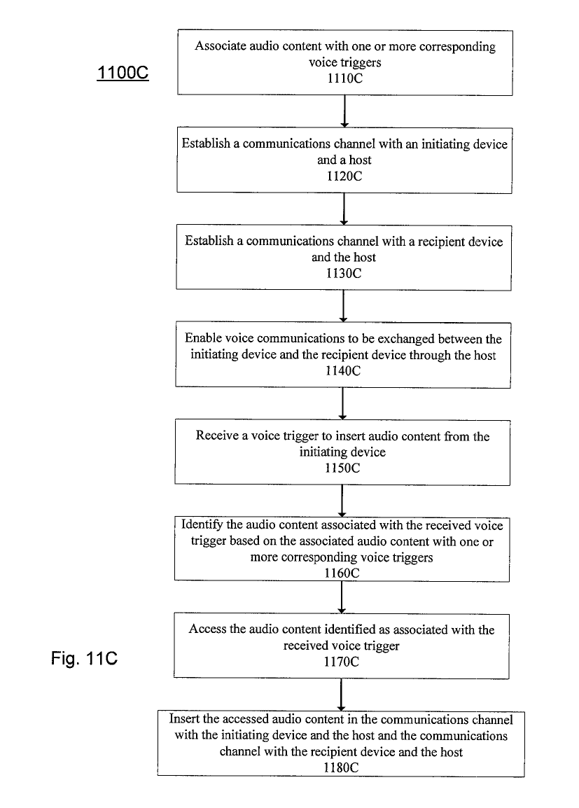

FIG. 11C is a flow chart of an exemplary process by which content is inserted into a communication channel with a host using voice triggers.

### DETAILED DESCRIPTION

A user may elect to make a telephony call more entertaining by injecting audio content into the telephone call. For example, a user calling a friend may press a key on a wireless phone in order to trigger rendering of a humorous quotation from a movie. In order to insert audio content into the communications channels (e.g., the telephony call), a communications channel may be established with an initiating device (e.g., a wireless phone used by an initiating user) and a host. A communications channel is then established with a recipient device and the host. Establishing a communications channel with a host may enable the initiating user to select triggers that are processed by the host in order to insert audio content into the communications channel.

Audio content may be associated with one or more corresponding triggers. For example, each of multiple popular lines from a movie may be associated with a key on a wireless phone (e.g., the ‘1’ key represents a first quote and the ‘2’ key represents a second quote). The host may associate the audio content with the trigger so that receipt, by the host, of the trigger may be used to insert audio content into the communications channel.

Voice communications may be exchanged across the communications channel between the initiating device and the recipient device, so that, for example, the calling user may speak with a called user. During a conversation, a user on the initiating device may press a key to generate a trigger. For example, the initiating device may generate dual tone multi-frequency (DTMF) signals indicative of a pressed key on the device keypad. The host identifies, based on the associated audio content with one or more corresponding triggers, the audio content associated with the received trigger. The audio content identified as associated with the received trigger is accessed and inserted in the communications channel.

In one instance, a user desiring to inject audio content into a telephony call may first place a telephony call to a hosted service (e.g., by dialing a telephony server). After authenticating the user, the hosted service allows the user to load one or more libraries during the call. The libraries may include multiple audio segments, and one or more of the audio segments may be associated with a trigger so that the user may selectively insert the audio content by invoking the corresponding trigger. In one example, the user establishes a communications channel with a hosted service. The hosted service may recognize the calling number as being associated with a particular user's account and ask the user to enter a security code associated with the account. After authenticating the user, the hosted service then may prompt the user to enter ‘1’ to load an Austin Powers profile of humorous quotations, and ‘2’ to load a Chris Farley profile of humorous quotations.

Thereafter, while connected with the hosted server, the user specifies a person to be called, for example, by using a keypad to enter the number of the called party. The hosted service calls the specified person, and, upon completing the placed call, establishes a communications channel (e.g., a telephony circuit or session) between the calling party and the called party through a host associated with the hosted service. The host loads a profile of audio content (e.g., a library of Chris Farley content) to be available for insertion, and associates inputs (e.g., triggers received in response to inputs on a reduced-entry keypad) with one or more selections of audio content. The calling party then may speak with the called party and also select the associated inputs in order to inject audio content from the loaded profile into the call. For example, if the Chris Farley profile has been loaded, the calling party may press ‘1’ to inject an audio content of Chris Farley saying “Holy Schneike!” The calling party then may continue to speak and/or further insert audio content.

The injected audio may supplant or be blended with microphone input from either calling party. For example, the participants may hear the calling party speak concurrently with injected audio. The calling party also may permit the called party to insert audio content into the communications channel by switching to a call state enabling the called party to insert content. For example, the calling party then may enable the called party to inject audio content by pressing ‘#’, thereby enabling the host to respond to instructions received from the called party. The called party then may press ‘2’ to inject an audio selection of Chris Farley saying, “that's gonna leave a mark!” In one implementation, the host monitors communications from each of the calling and the called parties separately in order to determine whether a signal is sent from the calling or called party, and act in response to that determination. For example, the host may determine that receipt of a first trigger from the calling party renders a first selection and receipt of the first trigger from the called party renders a second selection.

Furthermore, the host may insert audio content using dynamic time shifting in order to facilitate better conversation. In particular, after receiving a trigger to insert audio content, the host may delay the insertion if one or more of the parties is currently speaking. The host may wait until a communications channel is determined to be substantially silent or at a substantially constant volume or pitch before inserting the audio content. Specifically, the host may include a delay buffer where triggered audio content awaits an appropriate time for injection. Further, the host may dynamically shift volume of inserted audio content. In particular, the host may lower or raise volume of injected audio content based on monitored volume of one or more communications channels.

In another implementation, establishing the connection between the calling and called party may include enabling the calling party to instruct the host to call both the calling party and the called party separately, and combine the calls using to generate an end-end communications channel that supports, for example, three-way calling. During the call, the host may insert the audio content if one or more of the parties press a key to trigger insertion of audio content.

FIG. 1 illustrates an exemplary communication system 100 configured to insert audio content into a communication channel established by a host 115. The system 100 includes an initiating device 105 that accesses a host 115. The host 115, in turn, accesses a recipient device 125 through a network 120.

The initiating device 105 is configured to access the host 115 through a network 110. Examples of networks 110 and 120 include the Internet, the World Wide Web, a WAN (“Wide Area Network”), a LAN (“Local Area Network”), analog or digital wired and wireless telephone networks, radio, television, cable, satellite, and/or any other delivery mechanism for carrying content. The network 120 may be the same network 110, or a different network 120 that connects the initiating device 105 to the host 115.

The host 115 includes a processing device configured to insert rich media content (e.g., an audio content) into a communications channel. For example, the host 115 may be configured to establish a connection with an initiating device 105 and a recipient device 125. The host 105 then may be configured to enable voice communications between the initiating device 105 and the recipient device 125 and insert audio content in response to a trigger. In another configuration, the host 105 is configured to inject video communications into a video teleconference by replacing (or superimposing) conferencing video with a selected video segment.

The host 115 may include a general-purpose computer (e.g., a personal computer (PC)) capable of responding to and executing instructions in a defined mariner, a workstation, a notebook computer, a controller, a content database, a web interface, a short message peer-to-peer controller, a voice web controller, other components, or some combination of these items that is capable of responding to and executing instructions.

The initiating device 105 includes a device used to initiate a connection between an initiating user and other users. The initiating device 105 may include a wireless phone, a general-purpose computer (e.g., a personal computer (PC)) capable of responding to and executing instructions in a defined manner, a workstation, a notebook computer, a PDA (“Personal Digital Assistant”), a telephone, a component, other equipment, or some combination of these items that is capable of responding to and executing instructions. In one implementation, the initiating device 105 includes a telephone that initiates a telephone call to other devices.

The recipient device 125 is configured to receive communications initiated by another user and may include, for example, a PDA (“Personal Digital Assistant”), a wireless phone, a telephone, or another device. The recipient device 125 may include the various devices described above with respect to the initiating device 105 or other devices. For example, the initiating device 105 may include a telephone and the recipient device 125 may include a personal computer with a VOIP (Voice-over-Internet Protocol) interface configured to receive telephony calls.

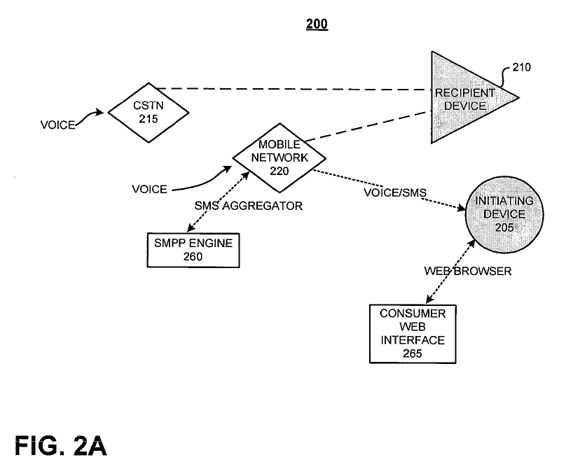

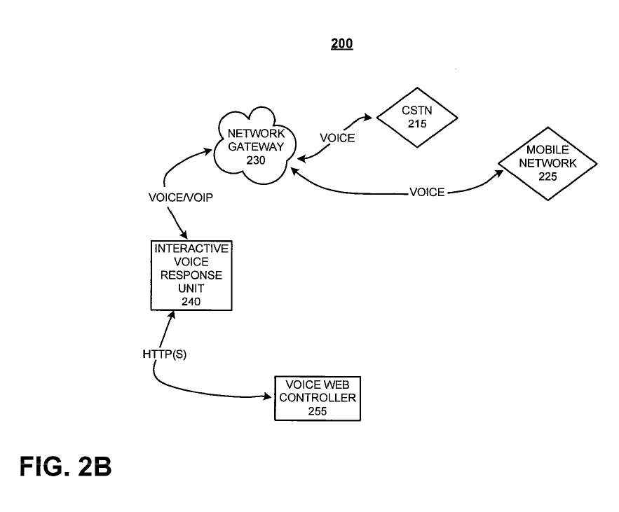

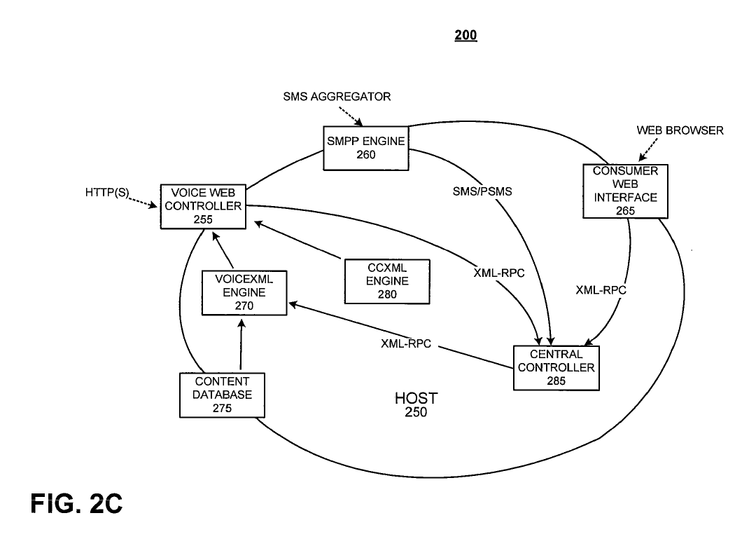

FIGS. 2A-2C illustrate an exemplary communication system 200 configured to insert audio content into a communication channel established by a host 250. Referring to FIGS. 2A-2C, the system 200 includes an initiating device 205, a recipient device 210, a circuit-switched telephone network 215, a mobile network 220, a network gateway 230, an interactive voice response unit 240, and a host 250. To aid understanding of the various components, the system 200 is shown as three separate FIGS. 2A, 2B, and 2C, which will each be discussed. The systems of FIGS. 2A-2C may represent aspects of single system or multiple systems.

In various implementations using various methods of audio content, insertion, various elements shown in FIGS. 2A-2C may be used. For example, audio content insertion may be triggered in response to receiving DTMF signals, software-generated trigger commands such as may be used by a Voice Over Internet Protocol (VOIP) communications, and/or messaging communications (e.g., short message service (SMS) or Multimedia Messaging service (MMS) messages).

A touch tone phone may be programmed to insert a DTMF signal in response receiving inputs on a keypad (i.e., “dialing” a number on the phone). A DTMF signal includes two sinusoids, one of a higher frequency and one of a lower frequency. Each key on the touch tone phone keypad is associated with a different DTMF signal. For example, the ‘1’ key is associated with 697 and 1209 hertz frequencies, and the ‘2’ key is associated with 770 and 1336 hertz frequencies. As touch tone phones are used to insert a DTMF signal, a host configured to process the DTMF signals received from a touch tone phone may insert audio content without the requiring special software to be installed on the touch tone phone. Rather, a phone's generation of DTMF signals may be used as the triggering event upon which an intermediary (e.g., a host) is configured to insert a specific audio clip associated with the DTMF signal.

Although DTMF signals may be used to insert audio content into a communications channel, other configurations may be used to trigger insertion of audio content into a communications channel. For example, a messaging protocol (e.g., SMS messaging) may be used to configure a communications channel to insert audio content and also to trigger insertion of the audio content. Although a SMS message generally includes a short text message, the text may be formatted to specify parameters that configure the communications channel and/or trigger insertion of audio content. Because a text message may permit a configuration to be specified with a greater degree of specificity than a reduced-entry keypad common to many wireless telephones, a SMS controller may be used to generate a more complex command enabling a greater degree of precision to be specified with respect to a library and/or also to specify more information in a single SMS message used as a trigger. As a result, a wireless telephone may include a software controller that reduces the navigation required to configure a communications channel. For example., the software controller may include a system of drop down menus that automatically write parameters for a communications channel to a single text message. In one configuration, use of SMS messages are used in association with a DTMF system. For example, an SMS controller may be used to trigger insertion of audio content while a user is navigating a DTMF menu.

In still another configuration, a user may use a VOIP or other Internet Protocol-based systems to send voice communications as digitized audio information from an initiating device through Internet Protocol (IP) networks (e.g., through the Internet). Specific audio segments may be associated with parameters appearing in IP packets or in other data structures. In one configuration, instructions to insert audio content are sent as control packets. In another configuration, instructions to insert audio content are sent as parameters in an IP packet that also includes voice content. For example, a payload in an IP packet may include compressed voice for the first specified number of bits and include content insertion parameters in the second specified number of bits. In still another configuration, instructions to insert audio content are sent as protocol information that encapsulates the audio content (e.g., the TCP port number). The data structure used represent a trigger for audio insertion need may be extensible in order to enable a particular configuration to be configured with a greater degree of specificity. The precision required to represent the specificity may not be available in other triggering modes that limit the format for triggers. For example, a maximum data length of a SMS message may preclude a user from specifying a particular manner in which an audio segment should be rendered.

Referring to FIG. 2A, the initiating device 205 may include the devices described above with respect to the initiating device 105 in FIG. 1. The initiating device 205 may establish a communications channel with other devices (e.g., a mobile device over the mobile network 220) using, for example, the circuit-switched telephone network 215 (connection not shown), the mobile network 220, or the consumer web interface 265 using hyper text transfer protocol (HTTP) to communicate with a web browser.

Similarly, the recipient device 210 may access the mobile network 220 and/or the circuit-switched telephone network 215 to establish a connection with other devices (e.g., recipient device 210).

The circuit-switched telephone network 215 may include a network configured to support circuit-switched telephone connections. The recipient device 210 and the network gateway 230 may access other devices through the circuit-switched telephone network 215.

The mobile network 220 may include a digital switched wireless telephone network that provides user services across wireless networks. For example, the network gateway 230, the recipient device 210, and the short message peer to peer (SMPP) controller 260 may access other devices through the mobile network 220.

Referring to FIG. 2B, the network gateway 230 enables access between multiple networks and/or across varying platforms. For example, the interactive voice response unit 240 may be configured to establish communications with the mobile network 220 and the circuit-switched telephone network 215 through the network gateway 230.

The interactive voice response unit 240 enables a user to enter instructions via triggers and voice communications. For example, the interactive voice response unit 240 may enable an inputted sequence of keys to configure a call (e.g., specify the number to be called). In another example, the interactive voice response unit may enable audio content to be inserted in response to receiving commands, such as voice or a keypad entry on a reduced-entry keypad on a mobile device utilizing VOIP communications. The VOIP communications may include signaling commands that manage the delivery of across networks by exchanging communications parameters with the network gateway 230 and/or interactive voice response unit 240. The interactive voice response unit 240 may interface with the network gateway 230 and the voice web controller 255 using extensible markup language remote procedure calls to enable procedure calls to be made between devices running under differing operating systems and/or differing environments.

Referring to FIG. 2C, the host 250 includes a processing device that may be used to establish one or more connections with devices such as the initiating device 205 and the recipient device 210, neither of which is shown in FIG. 2C. As shown, the host 250 includes a voice web controller 255, a SMPP engine 260, a consumer web interface 265, a voice extensible markup (VoiceXML) language engine 270, a content database 275, a call center extensible markup language (CCXML) engine 280, and a central controller 285.

The voice web controller 255 includes a system configured to direct, initiate, or receive calls for the host 250. The voice web controller 255 may reference a voice extensible markup language engine 270, the call center extensible markup language engine 280, and the central controller 285.

The short message peer to peer engine 260 may receive short service messages across the mobile network 220 and transfer information included in the short service message to the central controller 285.

The consumer web interface 265 may include a website with an interface that enables the initiating device 205 to specify instructions. For example, the consumer web interface 265 may be configured to receive instructions from the initiating device 205 and transfer the instructions to the central controller 285. The instructions may include information detailing when and how recipient device 210 should be contacted. The instructions also may relate to data items or a list of data items (e.g., audio content such as a library of audio content from a movie). The data items may be loaded from the content database 275 and inserted into the communications channel. The instructions also may specify the corresponding trigger used to insert the data item into the communications channel.

For example, an initiating device 205 may access a website in the consumer web interface 265 and select options to configure a call. The options may indicate that voice communications should be established with a particular user at a specified time and also that a profile of audio content should be loaded so that a user on initiating device 205 may insert content from the profile of audio content.

In one implementation, the consumer web interface 265 includes a list of buttons that, if selected, each insert a corresponding segment of audio content into the communications channel during a call. In another implementation, the consumer web interface is used to configure triggers to be used outside the consumer web interface 265 (e.g., each button on a phone is associated with a telephone keypad entry as a trigger). A library of audio content may be associated with a list of triggers and stored in a user's profile for use over multiple phone calls. The consumer web interface 265 may enable a user to select a configuration where the host 250 establishes a connection with the recipient device 210 without requiring a connection to be established with the initiating device 205. Alternatively, the host 250 may establish a connection with the initiating device 205, for example, by placing a call or receiving a call before establishing a connection with the recipient device 210.

The voice extensible markup language engine 270 is configured to direct the selective insertion of content from the content database 275 into the communications channel. For example, the voice web controller 255 may be configured to access the content database 275 using the voice extensible markup language engine 270.

The content database 275 may include a system or application configured to receive, store, and provide content that is rendered into the communications channel. The content database 275 may include, for example, a profile of audio and video excerpts from popular movies. The call center extensible markup language engine 280 includes a system and/or application configured to direct commands from the central controller 285 to the voice web controller 255.

The central controller 285 includes a system or controller configured to direct components in the host 250 and control the insertion of audio content, such as a segment of an audio clip or file into the communications channel. The audio content may be inserted in the communications channel by receiving instructions that trigger insertion of audio content. For example, a corresponding trigger may relate to a voice command (e.g., the user speaking the word “RAZZ” followed by a sequence of commands in order to configure the host to act in a specified manner), a telephone keypad entry, and/or a computer entry received through the consumer web interface 265. Thus, the audio content may be inserted in response to spoken commands, phone keypad, and/or Internet-based web instruction. The central controller 285 may continue to process instructions during the call, and may change the specified triggers and/or libraries that are used.

In one implementation, the central controller 285 is configured to process a call received from the initiating device 205 and establish a communications channel with the recipient device 210. For example, the initiating device 205 may use a wireless phone to establish a connection with the recipient device 210 across the mobile network 220 thru the host 250. The initiating device 205 may instruct an access network (e.g., the mobile network 225 or circuit-switched telephone network 215) to route the call through the host 250 by including placement digits in a connection request. For example, a user may enter extra dialed digits (e.g., by dialing ‘123’ before the phone number of the recipient device 210) in order to route voice communications through the host 230 before establishing the communications channel to the recipient device 210.

Alternatively, the central controller 285 may be configured to place a call to the initiating device 205 in order to initiate establishment of the communications channel. The central controller 285 then may be configured to establish a communications channel with the recipient device 210, and thereby establish the communications channel from the initiating device 205 to the recipient device 210 through the host 250.

In other implementations, the central controller 285 is configured through the use of SMS configuration messages that are sent to the SMPP engine 260. The central controller 285, having the obtained instructions from the SMS message, establishes the communications channel pursuant to the SMS message. For example, a user may send an SMS message to the host 250 with instructions identifying a party to be called, an indication of which profile of audio content should be loaded, an indication of which triggers should be used, and an indication of how the called party should be contacted (e.g., contact the called party using the mobile phone first, then contact the called party using the called party's home phone).

In yet another implementation, a VOIP control packet may be used to configure or initiate a telephony call. For example, a user may specify call parameters by speaking voice commands to a host 250. The call parameters then may be encoded in a control packet and sent to a network gateway for establishment of a connection.

In addition, the host 250 may be configured so that the initiating device 205 triggers specific audio content when specific telephone keypad keys are pressed. In particular, when a keypad key is pressed, a DTMF signal is sent from the initiating device 205 to the host 250. The host 250 removes the DTMF signal from the communications channel and renders the selected audio content such that both the recipient device 210 and the initiating device 205 receive the audio content.

Other configurations or components may be used. For example, the content database 275 may be operated by a different party than the organization operating the host 250. As a result, the host 250 may be configured to access the content database 265 across a network. Use of another parties content database may generate a recordation of which content is being accessed and by whom. For example, the content database 265 may record that a particular user injected five audio segments from a popular movie. The usage information then may be used to allocate royalties based on actual use.

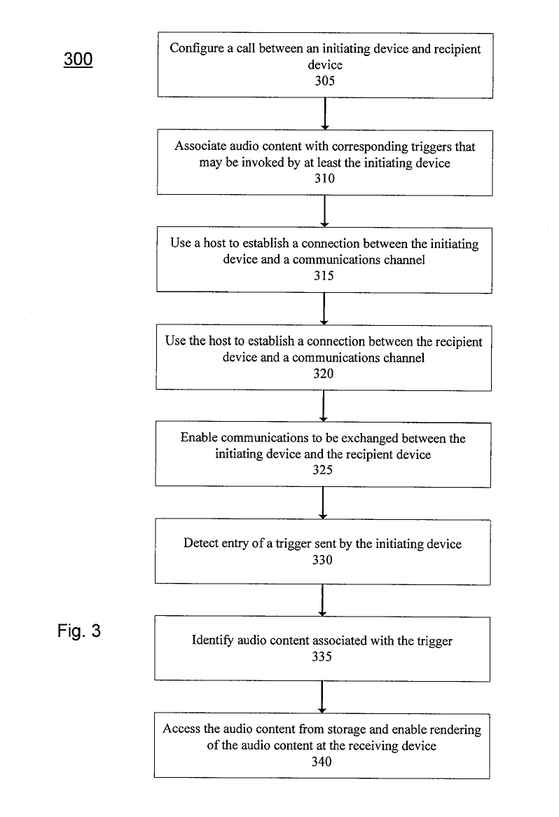

FIG. 3 is a flow chart 300 of an exemplary process by which content is inserted into a communications channel with a host. Typically, the operations described hereinafter with respect to flow chart 300 may be performed on the systems described with respect to FIGS. 1-2C. For example, the initiating device may include a wireless phone that initiates a telephone call to a host in order to insert a multimedia object into the communications channel. The initiating and receiving devices may use public switched telephone networks, circuit switched telephone networks, IP-based networks, or other networks. Implementations may include using a client on the initiating device that transmits commands to inject audio content.

An initiating user may desire to insert associated audio content into the communications with a called party. A call between an initiating device and a recipient device is configured using an intermediary through which the call passes (305). Configuring the call may include establishing a connection between the initiating device with the host across a network, for example, via a telephone call, or an SMS message. In one implementation, configuring a call may include configuring a home location register (HLR) database to conditionally direct calls through a host for audio content insertion. The conditions may include, for example, the identity of the caller, the identity of the recipient, or receipt of an SMS message or IP packets configured for audio content insertion. A call may be set up by configuring the HLR database to direct specified calls from the initiating device to a specific recipient device through the host, or may be set up by configuring the HLR database to direct calls from the initiating device that include a specified instruction. For example, a user may select a call to be an audio content insertion call using software at the initiating device. When the user places the call, the software includes an audio content command that triggers the HLR database to direct the call through the host.

Audio content, such as one or more audio clips, are associated with one or more corresponding triggers (310). Associating the audio content may include referencing a profile or database on the initiating device, the host, or both. In one implementation, the calling party may, before or during a call, send an indication of a profile of sound clips to be used. For example, the indication may be sent by selecting the numbered key associated with entries appearing in a menu generated by the host. Then, the audio content within the profile of sound clips to be used is associated with the one or more corresponding triggers. In another implementation, the indication is delivered through software on the initiating device. For example, the user at the initiating device may select a profile of sound clips to be used for a future call. The audio content within the profile of sound clips to be used is associated with the one or more corresponding triggers at the host or the initiating device.

Associating the audio content also may include uploading an audio file (or profile of audio files) to the host. For example, the corresponding triggers may include audio, digital, or mechanical cues that control the insertion of the audio content in the communications channel.

A connection between the initiating device and the communications channel is established (315). The initiating device may directly or indirectly establish the connection with the host. In one implementation using a direct connection, the initiating device places a phone call to (or receives a phone call from) the host. In another implementation using an indirect connection, the initiating device places a phone call to or receives a phone call from a phone number not associated with the host, though the call is routed through the host. For example, the HLR database may direct some or all calls meeting certain conditions through the host to enable audio content insertion. Similarly, a connection between the recipient device and the communications channel also is established (320). For example, the host may place a call to or receive a call from the recipient device. Also, using the HLR, the call may be routed through the host to the appropriate destination associated with the recipient device. Communications are then exchanged between the initiating device and the recipient device (325). In particular, the host connects with both of the initiating device and the recipient device such that the users associated with both devices may speak with each other.

In response to invocation of the one or more corresponding triggers, associated content is inserted into the communications channel (330). In particular, a user associated with the initiating device may trigger audio content insertion by pressing a key on a reduced-entry keypad. In one implementation, the trigger includes a DTMF signal sent in response to a user pressing a key. In another implementation, the trigger includes parameters appearing in IP packets (or an SMS message) sent by software at the initiating device in response to a user pressing a key. Audio content associated with the trigger is identified (335). For example, as different DTMFs signals or trigger commands may be associated with different audio content, the host may reference the associated audio content after receiving a DTMF or trigger command (e.g., different audio clips). The audio content is accessed from storage and rendering of the audio content at the receiving device is enabled (340). In particular, the identified audio content is retrieved for subsequent insertion into the established communication channel along with or instead of ongoing voice communication.

In one example, a first user, John, wishes to inject audio content during a telephone call with his friend Jane. John dials Jane on his mobile phone. At the carrier network for the mobile phone, an HRL database is accessed, which dictates that all calls placed from John's mobile phone to Jane's mobile phone should be directed through the host for audio content insertion. A call from John's mobile phone through the host and to Jane's Mobile phone is established. After Jane answers the call, John presses the ‘1’ key on his phone. John's phone inserts a DTMF signal associated with the ‘1’ key, and the signal is intercepted by the host. The host recognizes the DTMF signal, retrieves the sound clip associated with the ‘1’ key, and inserts the sound clip so that the famous segment, “what's up doc?” is rendered by both John's and Jane's mobile phones. Jane, confused by the identity of the caller, asks, “gosh, is this really that rabbit?” John then presses the ‘3’ key on his phone. John's phone then inserts a DTMF signal associated with the ‘3’ key, and the signal is intercepted by the host. The host recognizes the DTMF signal, retrieves the sound clip associated with the ‘3’ key, and inserts the sound clip so that “that's all folks” is rendered by both John's and Jane's mobile phones. John promptly hangs up.

In another example, Jane has since changed telephones to an IP-based mobile phone, and has plotted a responsive call to John. Jane initializes software on her mobile phone and places a call to John. The software is configured to transmit IP packets, along with the call data, that instructs the mobile carrier to direct the call through the host for audio content insertion. A call from Jane's mobile phone is established through the host to John's mobile phone. After John answers the call, Jane presses a key on her phone. Jane's phone generates a trigger in an IP packet in the call referencing a sound clip. The trigger is received by the host. The host recognizes the trigger as referencing the sound clip, retrieves the referenced sound clip, and inserts the sound clip so that the famous Star Wars segment, “Luke I am your father,” is rendered by both John's and Jane's mobile phones. John, stunned by the identity of the caller, asks “oh wow, Mr. Vader, you must have dialed the wrong number.” Jane then presses the another key on her phone. Jane's phone inserts another trigger in an IP packet in the call data referencing another sound clip. The trigger is received by the host. The host recognizes the next trigger as referencing another sound clip, retrieves the referenced sound clip, and inserts the sound clip so that the audio segment, “You don't know the power of the dark side,” is rendered by both John's and Jane's mobile phones. John, realizing that he is now participating in a telephony call enabling the insertion of audio content (presuming the recipient device is permitted to insert audio content), quickly presses the ‘2’ key on his phone. John's phone generates a DTMF signal associated with the ‘2’ key, which, in turn, is received by the host. The host processes the DTMF signal, retrieves the sound clip associated with the ‘2’ key, and inserts the associated audio content so that the audio segment, “Powerful you have become, the dark side I sense in you,” is rendered by both John's and Jane's mobile phones.

The previous examples illustrate one sequence for inserting audio content into a communications channel. Different operations, or a different orders of operations may be used. For example, the operations of establishing communications (315 and 320) and enabling of communications (325) may occur prior to the association of audio content with corresponding triggers (310). Also, additional or fewer steps may be used based on different requirements, capabilities, or preferences.

For example, in one implementation, a host is configured to present updates to a participant in the call. For example, a sales person calling a prospective customer may route the communications channel through a host configured in order to receive in-call analytics. For example, the host may be configured to identify excerpts of timely information useful during a call. The host then may insert the excerpts of timely information into the audio content transmitted to the sales person.

In one configuration, the analytics are based upon call setup information. Thus, a host may use the number of the called party to identify a called party's identity and employment. The host then may access press releases related to the company and/or the called party. Excerpts of this information then may be transmitted to the calling party during the conversation. The host may structure the amount of information that is, transmitted to the calling party so as to not interrupt the flow of the conversation. The calling party then may invoke a trigger that retrieves additional and more detailed information. Retrieval of additional and more detailed information also may be used in association with a previously stored excerpt of the calling party speaking for a period of time, thereby enabling the user retrieve a longer excerpt of information without interrupting the conversation.

In another configuration, the analytics are based on the characteristics of the conversation. The analytics may be based on the content, tone (e.g., intensity, pace, vocabulary) and/or volume of the conversation. For example, the host may detect the term “Everton” being spoken by the called party. As a result of detecting “Everton” and other terms being used, the host may determine that the called party is interested in a football match involving a particular English football team. The host then may transmit an audio excerpt to the calling party stating, “the calling party just mentioned Everton Football Club, which just tied Liverpool Football Club 0-0 at Anfield.” The calling user, desiring to sound well-versed in English football, could then offer up, “very fortunate break, for Everton in the derby.”

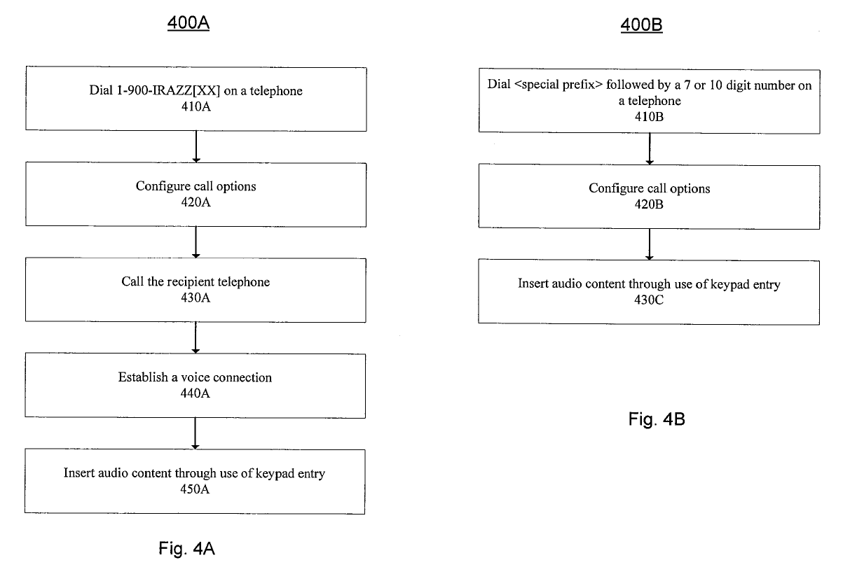

FIG. 4A is a flow chart 400A of an exemplary process by which audio content is inserted into a phone call established by establishing a communications channel with an audio content insertion gateway. The operations described hereinafter with respect to flow chart 400A may be performed, for example, on the systems described with respect FIGS. 1-2C. However, other systems may perform the operations described hereinafter.

Initially, a user connects to a telephone system by dialing 1-900-IRAZZ[XX] on a telephone (405A). In one implementation, the 1-900-IRAZZ[XX] number represents a pay-per-call number, and results in a monetary fee assessed to the user. The dialed number need not be a 900 or pay-per call number, as other types of called numbers may be used.

In various implementations, the last two digits, [XX], in the dialed number are used to specify a content profile to be loaded. Placing a call loads a content profile that specifies which keys on the keypad are used to trigger audio content insertion. For example, dialing 1-900-IRAZZ01 may result in a content profile featuring audio content of Bart Simpson and dialing 1-900IRAZZ99 may result in loading a content profile featuring audio content of Bugs Bunny. In one implementation, the last two digits, [XX], in the dialed number are used to specify the initial profile, and the user may toggle libraries during the call by, for example, tapping keys on the keypad to insert DTMF signals or generate other triggers. A list of content profiles may be publicly available. For example, a website at the consumer web interface 265 may maintain a list of dialed numbers and associated content profiles. The list may be periodically updated with new or different content profiles associated with new or different associated triggers. The user's identity may be verified by the recipient telephone system. The verification may be based on automatically available calling information, such as a caller identification number, or manually input information, such as a user entered “pin-code” associated with a user identity.

Call options are optionally configured (420A). For example, the user may be directed through an automated sequence of menus enabling configuration of call options (420A). The call options may enable selection of the recipient telephone number, specify whether the recipient may have access to audio content insertion, specify whether the call may be a multi-party call (e.g., a three-way call), and specify whether multiple content profiles are loaded. Specifying whether a recipient may insert audio content enables the recipient to use triggers to insert content from either the same profile as the initiating user or a different profile (e.g., an opposing profile). Specifying whether multiple content profiles may be used enables an initiating user to select different libraries or content profiles within a call.

Specifying whether the call is a multi-party call enables communications to be established with multiple recipient numbers. Separately, or in addition, specification of multi-party calls may enable some or all recipients to insert audio content. In one implementation, the user may specify in-call configuration options so that one or more recipient devices are not permitted to insert audio content for a particular call (or for any call). For example, a user may communicate to the host while configuring call options (420A) that a first recipient is permitted to insert audio content and a second recipient is not permitted to insert audio content. During a multi-party call, the host will selectively insert audio content to the initiating device and to the first recipient while not distributing the inserted audio content onto the portion of the communications channel established with the second (blocked) recipient.

Similarly, a called party may be blocked from receiving audio content. For example, in a conference call in which four parties are attending, a first user may specify that a specified call participant should not receive audio content inserted by the first user. As a result, the first user and the two other users may perceive the audio content while the particular user does not receive the inserted audio content. Similarly, a user may specify that audio content may not be inserted into a communications channel in which the user is participating. For example, the user may subscribe to a hosting service and set up a user profile that specifies no audio content (or types of audio content such as inappropriate audio content) may be inserted into communications channels in which the user is participating.

In still other implementations, the HLR database may be configured to block or filter communications channels between the second recipient and the host. For example, the host may notify the initiating user that the second recipient is permitted to be subject to audio content insertion while directing calls to the second recipient through the host. The filter may be established on the instructions of the second recipient, who does not wish to be the subject or participant in such calls. Alternatively, the filter may be established on the instructions of the initiating user, such as, for example, a parent that does not wish for a child to call particular recipients and insert audio selections.

The call configuration options may use a default configuration where user configuration is not required (or even enabled). Alternatively, the ability to selectively insert an audio content may be associated with a monetary fee (e.g., by participating in a subscription), where the total fee for the phone call is determined by the options selected.

The recipient telephone is called (430A) by the host. After the recipient answers the call, a voice connection is established (440A). The voice connection enables both users to hear each other in a voice based telephone call. Audio content then is inserted in response to receiving triggered generated by typing keys in the keypads of the phones (450A). For example, pressing a key may generate a DTMF signal, which triggers insertion of audio content on the host. A host may be configured to respond to triggers that enable on demand addition or updating of configuration options. For example, the ‘*’ and ‘#’ keys may be used to toggle content profiles, the ‘0’ key may be used to enable recipient users to insert audio content, and the ‘8’ key enables rotation of which user is enabled to insert clips when only one user is enabled at a time.

In some implementations, call configuration options are specified prior to the initiation of the phone call. For example, a user may log into a website, such as the consumer web interface 265, and specify one or more configuration options, as discussed above with respect to operation 420A and in FIG. 2C, and then place a call. In particular, the user may identify themselves at a website and select (or create) a custom content profile as well as other preferences. When the user later places a call, the host loads the selected content profile and/or preferences for the call in response to receiving identification information. For example, a user may be asked to identify themselves using a pin code may. Alternatively or in addition, the user may use his/her phone number as the unique identifier.

FIG. 4B is a flow chart 400B of an exemplary process by which audio content is inserted into a communication channel established by calling a phone number using an additional prefix. The operations described hereinafter with respect to flow chart 400B may be performed, for example, on the systems described with respect to FIGS. 1-2C. However, other systems may perform the operations described hereinafter.

Initially, a user establishes a communications channel with a host by dialing XXX-123-4567 on a telephone (410B). For example, the first X digit may represent an instruction for a network gateway to activate an audio content insertion capability. The second and third X digits may represent an instruction to load a particular content profile (e.g., load a library of audio content from a particular movie). The remainder of the dialed number information specifies the destination of the phone call so that the network gateway routes the call to the recipient.

For example, a user may dial 710-123-4567. In response to the ‘7,’ the network gateway routes the call through a host so as to enable insertion of audio content. The ‘10’ specifies a specific profile of audio content, and the remainder of the number specifies the recipient of the call. In one implementation, a switch receiving the ‘7’ digit as the first digit routes a call through the host to enable audio content insertion. The call then is completed to the recipient device.

After the recipient answers the call, call options are configured (420B). For example, a program enabling insertion of audio content may be invoked so that audio content is inserted in response to receiving an indication of a key press (430C). More precisely, a pressing a key on a wireless phone causes a DTMF signal to be generated, which in turn causes insertion of audio content into a communications channel.

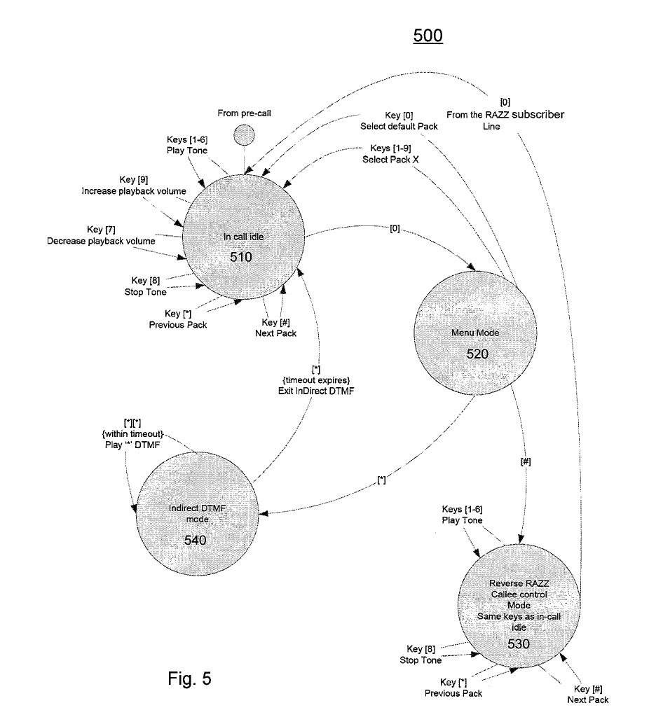

FIG. 5 is a flow chart 500 of an exemplary process employing indirect use of DTMF signals . The operations described hereinafter with respect to flow chart 500 may be performed, for example, on the systems described with respect to FIGS. 4A and 4B. However, other systems may also be used to perform the operations.

Systems employing a host configured to replace DTMF signals with audio content may not enable a user at an initiating device to use dial tones during a phone call. For example, a user at an initiating device may not be able to navigate menus at the recipient device (e.g., a voice mail messaging system). In order to preserve the ability of the initiating device to use DTMF signals to navigate, for example, a voice mail menu, the host may be configured to enable use of indirect DTMF signals. Specifically, the host maay be configured to selectively pass DTMF signals instead of or along with inserted audio content to either the recipient device, the initiating device, or both. The flow chart 500 describes an exemplary process enabling use of indirect DTMF signals.

After an initiating device, such as a mobile phone, establishes a communications channel through a host to a recipient device, the host sets the status of the communications channel to a “call idle” status 510. While in the “call idle” status 510, the host monitors the connection with the initiating device for DTMF signals. When a DTMF signal is identified, the host may insert an associated clip of audio content (i.e., play a tone) with keys ‘1’-‘6,’ toggle content profiles (i.e., change packs) with keys ‘*’ and ‘#,’ change volume level of future tones with keys ‘5’ and ‘9,’ stop a current tone insertion with the ‘8’ key, or change modes with the ‘0’ key. If receipt of a DTMF signal instructs the host to insert audio content, the received DTMF signal is replaced with audio content. Specifically, the recipient does not receive the DTMF signal sent by the initiating device.

After receiving a DTMF signal identified with the ‘0’ key, the host moves to a menu mode status 520. While in the menu mode status 520, the host continually monitors the connection with the initiating device for DTMF signals. When a DTMF signal is identified, the host return to an “in call” idle status 510 with a specific content profile with keys ‘1’-‘9,’ enter an indirect DTMF signal status 530 with key the ‘*’ key, or enter a reverse control mode 540 with the ‘#’ key.

If, while the communications channel is at the menu mode status 520, a DTMF signal identified with the ‘#’ key is received, the host enters the reverse control mode 530. In the reverse control mode 530, the host monitors the connection with the recipient device for DTMF signals. If a DTMF signal is identified, the host inserts an associated clip of audio content (i.e., play a tone) in response to receiving DTMF signals associated with keys ‘1’-‘6,’ toggle content profiles in response to receiving DTMF signals associated with keys ‘*’ and ‘#,’ stop a current tone insertion in response to receiving DTMF signals associated with the ‘8’ key, or change modes in response to receiving DTMF signals associated with the ‘0’ key. If an associated clip of audio content is to be inserted, the received DTMF signal is replaced with audio content. Specifically, the host does not transmit the DTMF signal to the initiating device.

If, while the communications channel is at the menu mode 520, a DTMF signal associated with the ‘*’ key is received, the host enters the indirect DTMF signal status 540. In the indirect DTMF signal status 540, the host monitors the connection with the recipient device for DTMF signals. If a DTMF signal is received, the host may forward the received DTMF signal to the recipient (e.g., those DTMF signals associated with the ‘1’-‘9,’ ‘0,’ and/or ‘#’ keys. If the host identifies two instances of the ‘*’ key as being received within a threshold amount of time, the host passes the ‘*’ DTMF signal to the recipient. If the host only detects a single instance of the ‘*’ key with the threshold amount of time, the host enters the in call idle status 510. By differentiating between the single and double instances of DTMF signals associated with a special trigger (e.g., the ‘*’ key), the host enables the caller to send indirect DTMF associated with the special key to the other device while also enabling a user to change the modes.

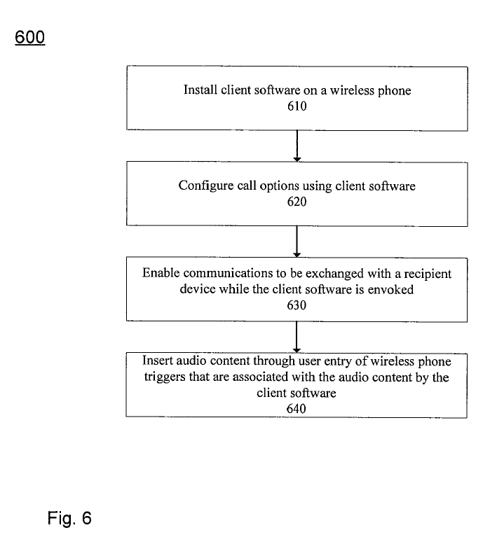

FIG. 6 is a flow chart 600 of an exemplary process by which audio content is inserted into a wireless communication channel established by software on a wireless phone. The operations described hereinafter with respect to flow chart 600 may be performed, for example, on the systems described with respect to FIGS. 1-2C. However, other systems may perform the operations described hereinafter.

Initially, client software is installed on a wireless phone (610). The client software includes a graphical user interface (GUI) enabling a user to select options. Installing the client software may be done in response to a user subscribing to a content-insertion service or otherwise engaging in a transaction in order to acquire an ability to insert audio content.

Call options are configured using client software on the initiating device (620). Communications are enabled to be exchanged with a recipient device while the client software is invoked (630). Audio content is inserted through user entry of wireless phone triggers that are associated with the audio content by the client software (640).

In one implementation, the client software communicates with a mobile network through use of a messaging application (e.g., SMS messaging). A GUI may present call configuration options and provide the information to a host through the exchange of parameters and triggers within a message. Specifically, client software on the initiating device may be configured, such that the selecting a trigger on the initiating device (e.g., pressing a key on a keypad) initiates the transmission of a message with a trigger for insertion of audio content that is associated with the pressed key. Triggers in the message are configured to instruct the host to insert a specific audio clip in the ongoing phone call. Alternatively, a wireless access protocol (WAP) application also may be used to provide communications that configure call options.

In one example, the following format within a text message is used to specify a configuration for connection where insertion of audio content is enabled:

[recipient device] [type of session] [content profile] [specific content] The recipient device parameter specifies the address (e.g., network location) of the recipient device by, for example, telephone number, Internet Protocol address, media access control address, online identity (e.g., email address or screen name), or another address. The type of session parameter specifies the type of call in which the audio content is to be inserted. The types of call may include a two-way call, a multi-party call, a “blast” call (as discussed below), or another type of call. The content profile parameter specifies a content profile that should be used (e.g., ‘The Godfather’ movie). The content profile parameter may be specific to the user or user device. Alternatively, the content profile parameter may be common to more than one user. The specific content parameter specifies which audio content should be inserted into the communication channel. The specific content parameter may be specific to the user or user device.

In another implementation, the client software establishes a socket directly with a host to configure call options. The client software may use the socket to specify a configuration. For example, the client software may select or setup a content profile, or specify a recipient number from a database stored in a host. In another example, the socket is used to select content profiles from the host and configure triggers before or during a call (e.g., after calling a recipient, a user configures and triggers audio content insertion). The client software may continue to communicate to the host through the socket during the call, and instruct the host to insert audio content in response to receiving a trigger.

Alternatively or in addition, parameters in a Transmission Control Protocol/Internet Protocol (TCP/IP) connection between a wireless device and the host may be established in conjunction with or instead of a socket. For calls associated with an IP communications session, the client software may process voice and data packets concurrently. For example, if a wireless phone uses an IP network, voice and control packets may be exchanged concurrently. Specifically, a single control channel transfers the audio data of the phone call and the inserted audio content (e.g., voice packets) as well as triggering information (e.g., control packets). The receiving device, or an intermediary (e.g., host or a network), may receive the data within the single control channel, and analyze the controlling information to trigger audio insertion. In one implementation, configuration of a content profile and selection may occur after the recipient is called. For example, a content insertion capability may be invoked after a recipient has been called.

In one implementation, an IP-based data packet is structured and arranged to use a first parameter (or offset) to specify a recipient device, a second parameter (or offset) to specify a type of session, a third parameter (or offset) to specify a content profile, and a fourth parameter (or offset) to specify an audio content for insertion.

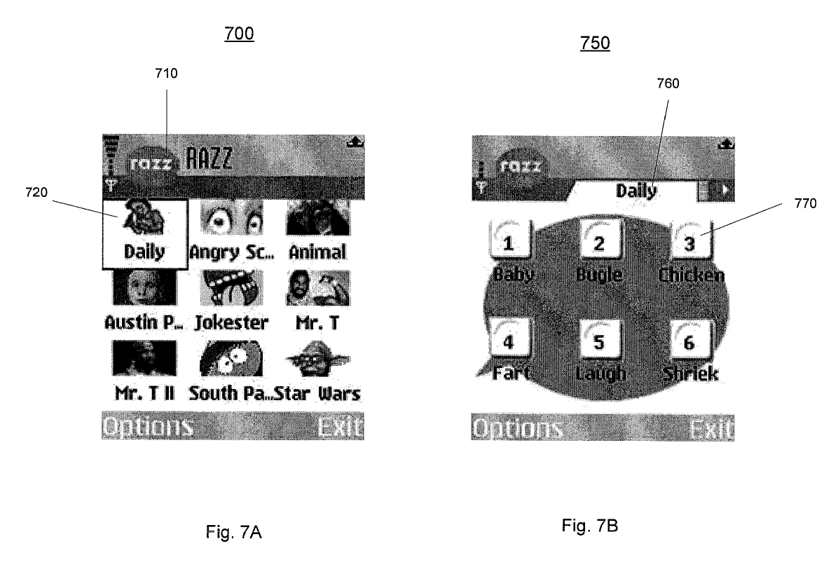

FIG. 7A illustrates an exemplary GUI 700 on a wireless telephone to select content profiles for insertion. GUI 700 may, for example, be used to implement the operations described with respect to flow chart 600 in FIG. 6. However, other operations may perform operations using the GUI 700 described hereinafter.

The GUI features a software icon 710 and content profile icons 720. The software icon 710 details the status of the software and includes information directed to the screen currently viewed. The content profile icons 720 detail the type of content included in each content profile shown on the GUI 700, and also include a picture associated with the content profile. For example, the daily content profile icon 720 includes audio content that change on a daily basis, while the Mr. T content profile includes audio content of Mr. T speaking (e.g., “I pity the fool!”). The available content profiles may be associated with a specific user account, and may be uploaded to a host by the user prior to presentation of GUI 700. For example, a user may load or configure a personal content profile on a website prior to loading the personal content profile using the GUI 700.

FIG. 7B illustrates an exemplary GUI 750 on a wireless telephone to select audio content for insertion. The GUI 750 may be used, for example, to implement the operations described with respect to flow chart 500 in FIG. 5. However, other operations may be performed using the GUI 750 described hereinafter.

The GUI 750 features a selected content profile indicator 760 and audio content icons 770. The selected content profile selected indicator 760 describes the content profile with which the audio content icons 740 are associated. The audio content icons 770 detail the audio content that may be selected (e.g., triggered) in the current screen (GUI 750). The audio content icons 770 include an associated key number and a text description of the audio content. Other key numbers may be used to trigger activation of options. For example, in one implementation, key number ‘7’ and ‘9’ are used to increase or decrease the volume of inserted audio content.

Content of the GUIs shown in FIG. 7A and FIG. 7B may be included in device software that is installed, updated during events (e.g., configuring a call), or updated continuously For example, the device software may come loaded with some of the content profiles. In another example, the structure of the profile is included with the device software while the actual audio content is loaded at a later time (e.g., the profile icons associated with content profiles may be come loaded with the device software while the associated audio content is not included in the device software). Alternatively, the audio content may be downloaded every time the software is loaded. Also, the audio clips or content profiles may be configured or updated by the user either at the device or by accessing the host, through, for example, a host generated website. Specifically, the user may program an audio clip macro, where a series of audio clips is played in response to receiving a macro trigger. For example, a series of three clips may be programmed to be played consecutively after input of a single key.

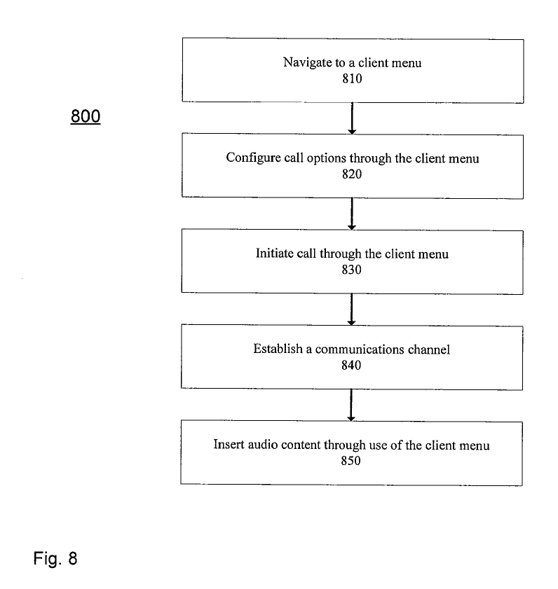

FIG. 8 is a flow chart 800 of an exemplary process by which audio content is inserted into a communication channel using a device. The operations described hereinafter with respect to flow chart 800 may be performed, for example, on the systems described with respect to FIGS. 1-2C. However, other systems may also be used to perform the operations.

Initially, a user navigates to a menu (810) and the user configures call options through the menu (820). For example, a user may use the menu to activate call configuration options that route a telephone call through an intermediary for insertion of audio content (e.g., by calling a number for a content intermediary or entering a prefix or a suffix that routes the call through an intermediary configured to insert audio content). In one implementation, the user engages in a transaction for the privilege of using enhanced services. For example, a user may pay a one-time fee, a monthly fee, a fee per use, a fee per library, or a fee per set number of audio content insertions (e.g., a $1 charge per 10 insertions). The call is initiated through the menu (830). A voice connection is established (840), and audio content is inserted through use of the menu (850).

In one implementation, a user navigates to a menu (810) that is hosted on an Internet website. By selecting options displayed on the website, the user may configure the call options (820) and initiate the call (830). A host associated with the website establishes a communication channel (840) and enables the user to insert voice into the communications channel. For example, the host may be configured to recognize signals associated with entered keys and insert audio content associated with the entered keys in response. Content is inserted into the communication channel in response to the user selecting options on the website (850). The user then may participate in the conversation before and after the rendering of the audio content that has been inserted. Recipients then may respond by speaking or inserting audio content of their own (presuming the recipient is permitted and/or has the capability to insert audio content from an intermediary).

In addition to using a website to configure a call and/or trigger audio content, a call may be configured and audio content may be triggered using a peripheral computer that is not acting as a voice participant, the peripheral computer interfacing with the host performing the audio insertion. In another implementation, a user interfaces with a host through a cable or satellite set top box. A user may navigate and select options on the menu of a television connected to a cable or satellite box. Through the box, content profiles may be selected and/or downloaded, a call may be configured, and audio content insertion may be triggered. For example, a user watching a television program may be presented with a content profile related to the television program. The user may, using a remote control, place a call and insert audio content related to the program. Fees directed to audio insertion may be included with the fee for cable or satellite television. Alternatively, the transaction may be executed using an established account with a cable or satellite television provider.

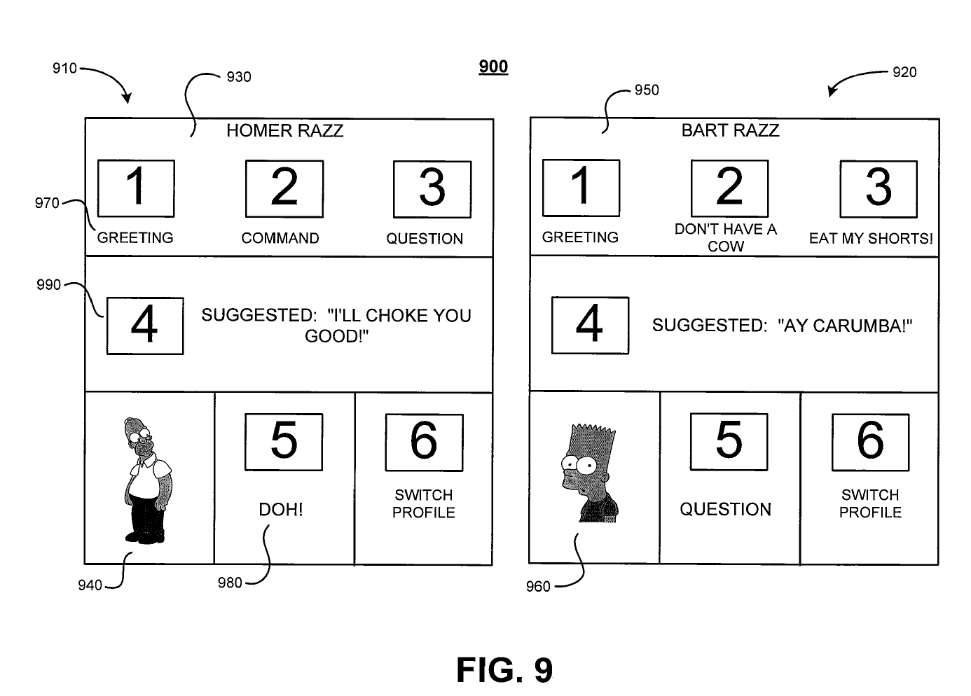

FIG. 9 illustrates an exemplary graphical user interface shown on two wireless telephones that are “dueling.” In FIG. 9, a combined display 900 with GUIs 910 and 920 used by “dueling devices.” The devices are deemed “dueling” in that the user on each device is trying to counter witty “remarks” (inserted audio content) from the other user with their own “witty” remarks. The GUIs 900 include a calling user GUI 910 and a recipient user GUI 920. The GUI 900 also includes a calling content profile 930 and a recipient content profile 940. The calling content profile 930 (the “Homer Razz”) is selected by the user and is associated with a calling content profile icon 940. As shown, the recipient content profile 950 is the “Bart Razz” and may be selected by the caller in response to determining that the calling user 910 has loaded or is using the “Homer Razz” content profile. Alternatively, the host may suggest the “Bart Razz” as an appropriate “opposing profile” in response to detecting that the calling user has loaded the “Homer Razz.” The recipient content profile 950 is associated with a recipient content profile icon 960.

GUI 910 also includes an “audio content-by-category” indicator 970, an “audio content-by-content-description” indicator 990, and a “suggested-next-segment” indicator 990. The “audio content-by-category” indicator 970 displays an option to insert an audio content of a specific category of segment contents (e.g., greeting, question, command). The “audio content-by-content-description” indicator 980 includes an option to insert audio content with a specific content (e.g., insert audio content with a specific text). In GUIs 910 and 920, the user may press a key to navigate or toggle a list of greetings. Specifically, in one implementation, the user uses the ‘#’ and ‘*’ keys to scroll through various available menus of greetings, or various available key configuration of greetings. Further, users may scroll through sub-menus of greetings, where sub menus present a list of available sound clips available for insertion. For example, a key may be designated as scrolling through only the “suggested-next-segment” indicator 990. The user may press the designated key until a preferred clip appears as available as the suggested-next-segment.

The “suggested-next-segment” 990 includes an option to insert audio content that is chosen by the host as an appropriate next segment. The host may chose or suggest the appropriate next segment of audio content by considering behaviors of the users, such as, silence, and content, tone, pitch, or intensity of voice. The host may also analyze which audio content has already been played by either callers. For example, if a user inserts audio content identified as a greeting, the host may suggest a question segment in response so as to continue a conversation. Also, if a host identifies a participant as high intensity recipient, the host may suggest a high intensity segment to be inserted in response so as to match the high intensity.

In one implementation, after the host identifies or suggests an audio segment for insertion, the hosts sends a description of the segment to the device. The description may include text, graphics, or other media, and may be sent using SMS messaging or IP based data packets. The device may update the GUI 910 as new recommendations are received.

One such dueling phone call is now described. First, a calling user subscribing to a content insertion service selects a Homer Simpson content profile in preparation for a dueling session with a recipient user. The calling user then calls the recipient user. The recipient user receives the phone call and is recognized as a subscriber to the content insertion service. As a result, the recipient user is presented with a suggested opposing content profile of Bart Simpson, while also being enabled to access other content profiles. The recipient user selects the Bart Simpson content profile. The calling user then pushes ‘1’ on the keypad, triggering insertion of the greeting “Hey Bart!” The host detects that a greeting has been received and suggests a responsive greeting which the recipient inserts by pushing ‘4’ on the keypad, rendering the audio content “what's up Man?” The calling user then pushes ‘6’ on the keypad and is presented a list of other content profiles, highlighting similar content profiles. The user then selects a Mr. Burns content profile and injects audio content with a quotation of Mr. Burns.

In various implementations, metatags are associated with the inserted audio content. The metatags are sent with the data of the audio content and may specify which key has been pressed or what audio content is being sent. Specifically, the metatag may include a clip number that is unique for a specific audio content. The host may read the metatag and use the information in automating audio content insertion.

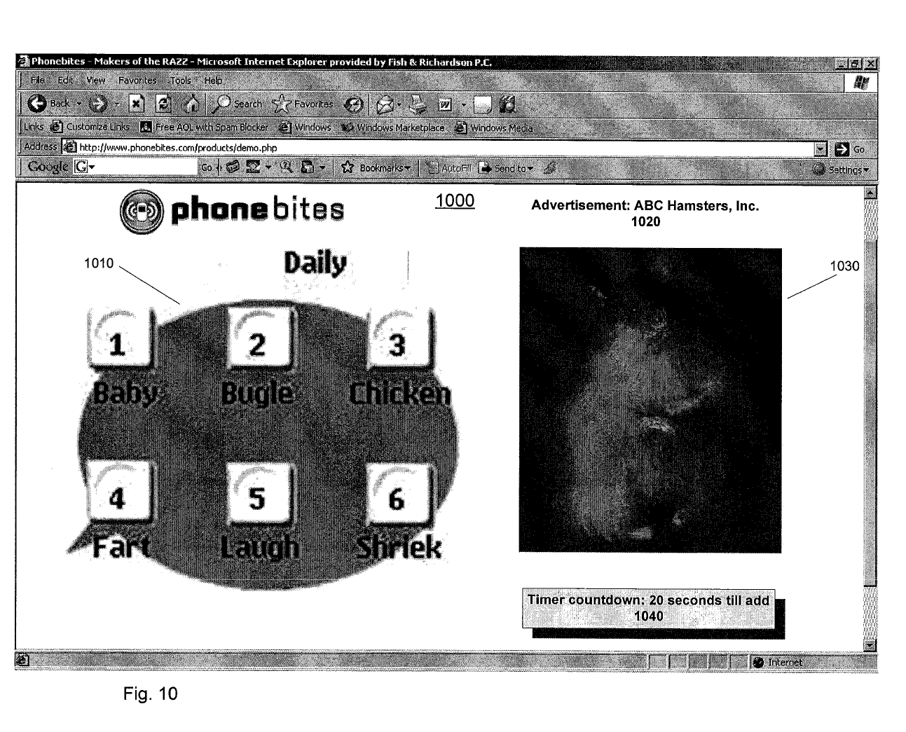

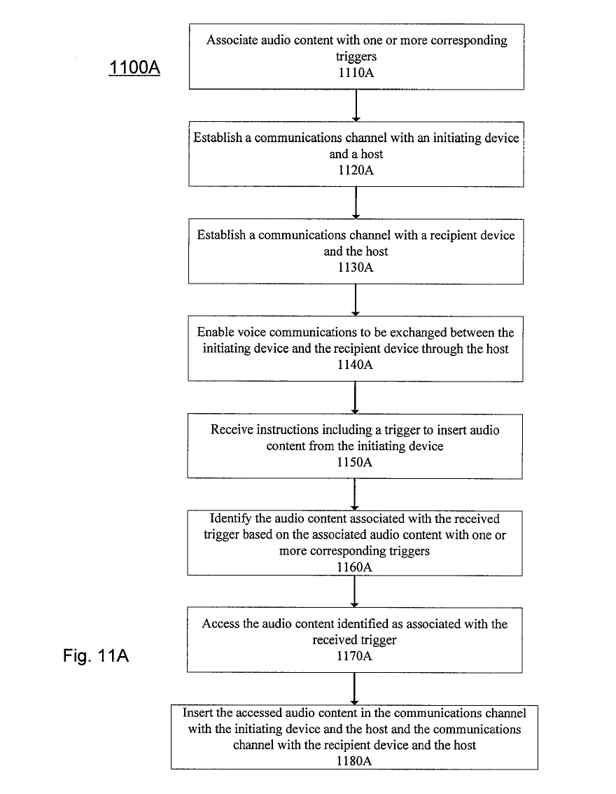

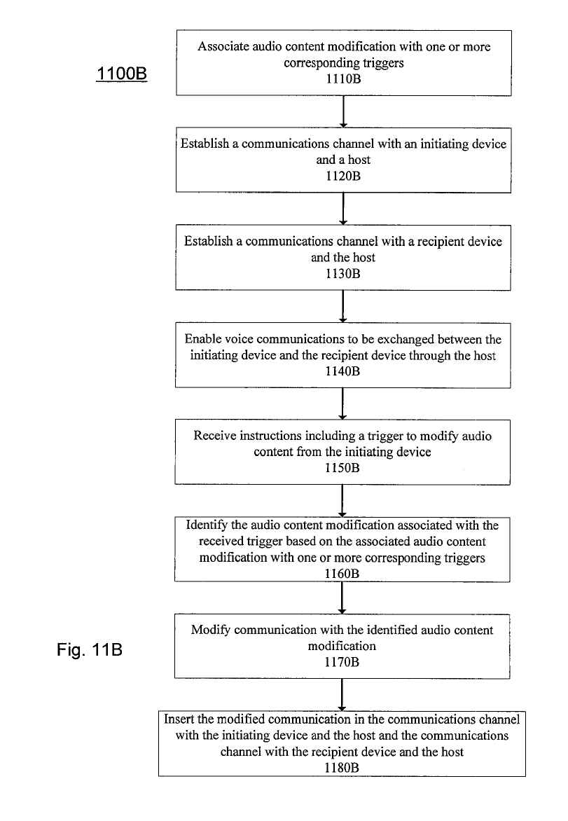

FIG. 10 illustrates an exemplary GUI 1000 on a website enabling a user to select audio content predicated upon simultaneously placement of advertisements. In some implementations, the capability to insert audio content is predicated upon subscribing to a content insertion service. In other implementations, the service may be subsidized or offered by providing a degree of capability in exchange for agreeing to receive advertisements.

GUI 1000 enables a user to control audio content insertion in a phone while showing the user an advertisement 1030. During a phone call, the user is encouraged to select a advertisement 1030 before an elapsed period of time expires. If the user clicks on the advertisement 1030 before the elapsed period of time expires, a new advertisement is retrieved and the timer may be reset. Clicking an advertisement may open a window or link to more detailed content related to the advertisement. If the user does not select the advertisement before the elapsed period of time expires, the audio insertion may be temporarily blocked while an advertisement is inserted into the phone call. A new advertisement then may be shown and the timer reset.

In one implementation, audio content insertion is predicated upon a system of credits. Each call, audio content insertion, or elapsed period of time may require a specified amount of credits. A user may gain more credits by selecting an advertisement, listening to an inserted advertisement, or paying a fee.

The GUI 1000 includes an audio content insertion menu 1010, an advertisement summary 1020, an advertisement 1030, and an advertisement insertion timer 1040. The audio content insertion menu 1010 enables a user to select audio content to be injected into a phone call. The advertisement summary 1020 details the product or company which the advertisement is directed to. The advertisement summary 1020 may include text or a hyperlink. As shown, the advertisement 1030 includes a picture or video advertisement. However, the advertisement 1030 also may include a hyperlink. The advertisement 1030 may be chosen based on a user profile, prior use, and/or the chosen content profile. The advertisement insertion timer 1040 displays time remaining before an audio content insertion capability expires. When the call is terminated, a screen detailing the number of advertisements viewed and/or heard during the call is shown to the user. The screen displays the advertisement or a summary of the advertisement enabling the user to revisit a previously-rendered advertisement. After the call is initiated, an advertisement may be inserted. During the call, an advertisement may be inserted periodically or after a set number of audio content insertions.

In other implementations, a user may use various platforms to initiate a call. Specifically, the user may configure a phone call using an Internet website, establish the communications channel by calling with a telephone, and insert audio content by inputting to the website during the live phone call.

In various implementations, users may setup a “blast” call such that one or more predetermined clips are played by to multiple users through a phone call that does not require user participation when a trigger is activated. The “blast” call may be configured through any of configured a call described previously. For example, a user may configure a call by navigating to a website over the Internet and inputting instructions.

FIG. 11A is a flow chart 1100A of an exemplary process by which content is inserted into a communications channel with a host. The operations described hereinafter with respect to flow chart 1100A may be performed on the systems described with respect to FIGS. 1-2C. The initiating and receiving devices may use public switched telephone networks, circuit switched telephone networks, IP-based networks, or other networks.

In the process, audio content is associated with one or more corresponding triggers (1110A). Associating the audio content may include referencing a profile or database on the initiating device, the host, or both. For example, in one implementation, the calling party may, before or during a call, send an indication of a profile of sound clips to be used. Associating audio content may include associating specific sound clips or associating a modification to sound clips or communication. In particular, associating a modification to communication may include associating a modification profile to be used to modify voice communication between the initiating device and the recipient device. For example, a first key or screen selection may be associated with a “Darth Vadar” modification to the user's communication (e.g., spoken voice) and a second key or screen selection may be associated with a “chipmunk” modification to the user's voice.

Associating audio content may include associating the audio content with voice triggers. In particular, the audio content may be associated with one or more spoken words. In one implementation, the spoken words may be determined by the user. For example, a user may associate the spoken words “bad guy” with a Darth Vadar sound clip, content profile, or voice modification, and the term “animal” with a chipmunk sound clip, content profile, or voice modification. Further, in an established communication channel, the user may speak “bad guy” to trigger the insertion of a sound clip, the selection of a content profile, or the modification of future voice communication. In another implementation, the user must speak a prompting term following by the associated voice trigger. Specifically, the user must speak “Razz, bad guy.” The host may not insert part or all of the prompting term or the associated voice trigger in established communications channels. In particular, the recipient device may not be sent the spoken term “Razz” or “bad guy.”

A communications channel with an initiating device and a host is established (1120A). In one implementation, establishing a communications channel includes placing a phone call to, or receiving a phone call from, the host. In another implementation, establishing a communications channel includes using the initiating device to place a phone call to or receiving a phone call from a phone number not associated with the host, where the call is routed through the host. A communications channel associated with a recipient device and the host is established (1130A). For example, using the HLR, a call may be routed through the host to the appropriate destination associated with the recipient device. Voice communications are enabled to be exchanged between the initiating device and the recipient device through the host (1140A). In particular, the users of both the initiating device and the recipient device are enabled to speak with each other.

Instructions including a trigger to insert audio content from the initiating device are received (1150A). Receiving instructions may include, for example, receiving a trigger within a DTMF signal, an SMS message, IP based data packets, or other data packets. In voice networks incorporating IP voice data, the triggers may be intermixed with the voice data. Specifically, a host, while receiving streamed data packets including voice data, may also receive a data packet with a trigger. In other implementations, data packets including a trigger may be sent separately from data packets including voice data. For example, a voice network may be configured to send voice data without the use of data packets as well as being configured to send data with the use of data packets. In such a network, a host may receive voice communication in a communication channel without data packets while concurrently receiving data packets including a trigger.

The audio content associated with the received trigger is identified based on the associated audio content with one or more corresponding triggers (1160A). For example, as different DTMFs signals data packets may be associated with different audio content, the host may reference the associated audio content (e.g., different audio clips) after receiving a DTMF or data packet. Identifying audio content may include identifying audio content modification, such as a modification profile to be used to modify communications. The audio content identified as associated with the received trigger is accessed (1170A).

In particular, the identified audio content may be retrieved for subsequent insertion into the established communication channel along with or instead of ongoing voice communication. In implementations employing audio content modification, accessing the audio content may include additional or different steps. For example, a program or module may be accessed. Different programs or module may be accessed for different identified audio content. For example, a first program may be accessed for a first identified voice modification profile and a second program may be accessed for a second identified voice modification profile. Alternatively, a single program is accessed for various identified voice modification profiles. Accessing audio content may include modifying communication with identified audio content modification.

The accessed audio content is inserted in the communications channel with the initiating device and the host and the communications channel with the recipient device and the host (1180A).

FIGS. 11B-11C represent two implementations of the process 1100A of FIG. 11A. FIG. 11B is a flow chart 1100B of an exemplary process by which content is inserted into a communications channel with a host. The operations described hereinafter with respect to flow chart 1100B may be performed on the systems described with respect to FIGS. 1-2C. The initiating and receiving devices may use public switched telephone networks, circuit switched telephone networks, IP-based networks, or other networks.

In the process, audio content modification is associated with one or more corresponding triggers (1110B). A communications channel with an initiating device and a host is established (1120B), a communications channel with a recipient device and the host is established (1130B). Voice communications are enabled to be exchanged between the initiating device and the recipient device through the host (1140B). Instructions including a trigger to modify audio content from the initiating device are received (1150B). For example, the user may select a type of modification in a content profile, such as “Darth Vadar” voice. The selection may prompt the generation and/or sending of a trigger indicating “Dark Vadar” voice has been selected.

The audio content modification associated with the received trigger is identified based on the associated audio content modification with one or more corresponding triggers (1160B). Communication is modified with the identified audio content modification (1170B). For example, all voice received by the host from the recipient device may be modified according to a “Darth Vadar” program. The spoken voice, after modification, sounds substantially similar to the voice of Dark Vadar. The modified communication is inserted in the communications channel with the initiating device and the host and the communications channel with the recipient device and the host (1180B).

FIG. 11C is a flow chart 1100C of an exemplary process by which content is inserted into a communications channel with a host. The operations described hereinafter with respect to flow chart 1100C may be performed on the systems described with respect to FIGS. 1-2C. The initiating and receiving devices may use public switched telephone networks, circuit switched telephone networks, IP-based networks, or other networks.

In the process, audio content is associated with one or more corresponding voice triggers (1110C). A communications channel associated with an initiating device and a host is established (1120C), a communications channel associated with a recipient device and the host is established (1130C). Voice communications are enabled to be exchanged between the initiating device and the recipient device through the host (1140C). A voice trigger to insert audio content from the initiating device is received (1150C). For example, the user may speak “Darth Vadar voice.” The host may recognize the term as a trigger for selecting audio content insertion or modification.

The audio content associated with the received voice trigger is identified based on the associated audio content with one or more corresponding voice triggers (1160C). The audio content identified as associated with the received voice trigger is accessed (1170C). The accessed audio content is inserted in the communications channel with the initiating device and the host and the communications channel with the recipient device and the host (1180C).

The previous examples illustrate various sequences for inserting audio content into a communications channel. Different operations, or a different orders of operations may be used. For example, the operations of establishing communications (1120A-11020C and 1130A-1130C) and enabling of communications (1140A-1140C) may occur prior to the association of audio content with corresponding triggers (1110A-110C). Also, additional or fewer steps may be used based on different requirements, capabilities, or preferences.

What is claimed is:

1. A method of inserting audio content into one or more communications channels, the method comprising:
associating audio content with one or more corresponding triggers;
establishing a communications channel with an initiating device and a host;
establishing a communications channel with a recipient device and the host;
enabling voice communications to be exchanged, through the host, between the initiating device and the recipient device; and
receiving, from the initiating device, a dual tone multi-frequency (DTMF signal) indicative of a pressed key on the device keypad;
identifying, based on the associated audio content with one or more corresponding triggers, the audio content associated with the received DTMF;
accessing the audio content identified as associated with the received DTMF;
inserting the accessed audio content in the communications channel with the initiating device and the host and the communications channel with the recipient device and the host.

2. The method of claim 1 wherein establishing the communications channel with the initiating device and the host includes initiating a telephone call from a user associated with the initiating device to the host and/or establishing the communications channel with the recipient device and the host includes initiating a telephone call from a user associated with the recipient device to the host.

3. The method of claim 1 wherein associating audio content with one or more corresponding triggers includes receiving configuration input over the Internet.

4. The method of claim 3 further comprising:
receiving, over the Internet, call configuration options;
associating, the received configuration options with either a user identity or a calling device; and
storing the configuration options; and
accessing the configuration options in response to a phone call from either the user identity or the calling device.

5. The method of claim 4 wherein receiving call configuration options includes receiving an indication of specific audio content to be associated.

6. The method of claim 4 wherein receiving call configuration options includes receiving an indication of specific triggers audio content is to be associated with.

7. The method of claim 1 further comprising:
receiving, from the recipient device, a further DTMF indicative of a pressed key on the device keypad;
identifying, based on the associated audio content with one or more corresponding triggers, the audio content associated with the received further DTMF;
accessing further audio content identified as associated with the received further DTMF;
inserting the accessed further audio content in the communications channel with the initiating device and the host and the communications channel with the recipient device and the host.

8. The method of claim 1 farther comprising:
receiving, from the initiating device, a different DTMF indicative of a pressed key on the device keypad;
identifying that the received DTMF is associated with altering which audio content is associated with the corresponding triggers;
altering which audio content is associated with the corresponding triggers accessing the audio content identified as associated with the received DTMF;
again receiving, from the initiating device, the first DTMF;
identifying, based on the associated audio content with one or more corresponding triggers, different audio content associated with the first DTMF;
accessing the different audio content identified as associated with the received DTMF;
inserting the accessed different audio content in the communications channel with the initiating device and the host and the communications channel with the recipient device and the host.

9. The method of claim 1 farther comprising:
receiving, from the initiating device, a different DTMF indicative of a pressed key on the device keypad;
identifying that the received DTMF is associated with altering whether audio content is inserted or DTMF is passed;
altering whether audio content is inserted or DTMF is passed;
again receiving, from the initiating device, the first DTMF;
passing the first DTMF to the recipient device.

10. The method of claim 9 wherein passing the first DTMF to the recipient device includes reproducing the first DTMF.

11. The method of claim 1 wherein the communications channel with the initiating device and the host and the communications channel with the recipient device and the host are the same communications channel.

12. A method of inserting audio content into one or more communications channels, the method comprising:
associating audio content with one or more corresponding triggers;
establishing a communications channel with an initiating device and a host;
establishing a communications channel with a recipient device and the host;
enabling voice communications to be exchanged, through the host, between the initiating device and the recipient device; and
receiving, from the initiating device, an SMS message including a trigger to insert audio content;
identifying, based on the associated audio content with one or more corresponding triggers, the audio content associated with the received trigger;
accessing the audio content identified as associated with the received trigger;
inserting the accessed audio content in the communications channel with the initiating device and the host and the communications channel with the recipient device and the host.

13. The method of claim 12 wherein establishing the communications channel with the initiating device and the host includes initiating a telephone call from a user associated with the initiating device to the host and/or establishing the communications channel with the recipient device and the host includes initiating a telephone call from a user associated with the recipient device to the host.

14. The method of claim 12 wherein associating audio content with one or more corresponding triggers includes receiving configuration input over the Internet.

15. The method of claim 14 further comprising:
receiving an SMS message including call configuration options;
associating, the received configuration options with either a user identity or a calling device; and
storing the configuration options; and
accessing the configuration options in response to a phone call from either the user identity or the calling device.

16. The method of claim 15 wherein receiving call configuration options includes receiving an indication of specific audio content to be associated.

17. The method of claim 15 wherein receiving call configuration options includes receiving an indication of specific triggers audio content is to be associated with.

18. The method of claim 12 further comprising:
receiving, from the recipient device, an SMS message including a further trigger;
identifying, based on the associated audio content with one or more corresponding triggers, the audio content associated with the received further trigger;
accessing further audio content identified as associated with the received further trigger;
inserting the accessed further audio content in the communications channel with the initiating device and the host and the communications channel with the recipient device and the host.

19. The method of claim 12 wherein the communications channel with the initiating device and the host and the communications channel with the recipient device and the host are the same communications channel.

20. The method of claim 12 wherein receiving an SMS includes receiving a multimedia message service message.

21. A method of inserting audio content into one or more communications channels, the method comprising:
associating audio content with one or more corresponding triggers;
establishing a communications channel with an initiating device and a host;
establishing a communications channel with a recipient device and the host;
enabling voice communications to be exchanged, through the host, between the initiating device and the recipient device; and
receiving, from the initiating device, instructions including a trigger to insert audio content;
identifying, based on the associated audio content with one or more corresponding triggers, the audio content associated with the received trigger;
accessing the audio content identified as associated with the received trigger;
inserting the accessed audio content in the communications channel with the initiating device and the host and the communications channel with the recipient device and the host.

22. The method of claim 21 wherein establishing the communications channel with the initiating device and the host includes initiating a telephone call from a user associated with the initiating device to the host and/or establishing the communications channel with the recipient device and the host includes initiating a telephone call from a user associated with the recipient device to the host.

23. The method of claim 21 wherein associating audio content with one or more corresponding triggers includes receiving configuration input over the Internet.

24. The method of claim 23 further comprising:
receiving data packets including call configuration options;
associating, the received configuration options with either a user identity or a calling device; and
storing the configuration options; and
accessing the configuration options in response to a phone call from either the user identity or the calling device.

25. The method of claim 24 wherein receiving call configuration options includes receiving an indication of specific audio content to be associated.

26. The method of claim 24 wherein receiving call configuration options includes receiving an indication of specific triggers audio content is to be associated with.

27. The method of claim 21 wherein receiving instructions including a trigger includes receiving data packets including a trigger.

28. The method of claim 27 wherein receiving data packets includes receiving Internet Protocol based data packets including a trigger.

29. The method of claim 27 wherein receiving data packets includes receiving data packets intermixing voice and trigger data.

30. The method of claim 27 wherein receiving data packets includes receiving an SMS message.

31. The method of claim 27 wherein receiving data packets includes receiving separate data packets including voice data separately from data packets including trigger data.

32. The method of claim 27 further comprising:
receiving, from the recipient device, a data packet based message including a further trigger;
identifying, based on the associated audio content with one or more corresponding triggers, the audio content associated with the received further trigger;
accessing further audio content identified as associated with the received further trigger;
inserting the accessed further audio content in the communications channel with the initiating device and the host and the communications channel with the recipient device and the host.

33. The method of claim 21 wherein the communications channel with the initiating device and the host and the communications channel with the recipient device and the host are the same communications channel.

34. The method of claim 21 wherein:
associating audio content includes associating audio content modification with one or more corresponding triggers;
receiving instructions including a trigger to insert audio content includes receiving instructions including a trigger to modify audio content from the initiating device;
identifying the audio content associated with the received trigger includes identifying the audio content modification associated with the received trigger based on the associated audio content modification with one or more corresponding triggers;
accessing the audio content includes modifying communication with the identified audio content modification; and
inserting the accessed audio content in the communications channel includes inserting the modified communication in the communications channel with the initiating device and the host and the communications channel with the recipient device and the host.

35. The method of claim 21 wherein:
associating audio content includes associating audio content with one or more corresponding voice triggers;
receiving instructions including a trigger to insert audio content includes receiving a voice trigger to insert audio content from the initiating device;
identifying the audio content associated with the received trigger includes identifying the audio content associated with the received voice trigger based on the associated audio content with one or more corresponding voice triggers; and
accessing the audio content includes accessing the audio content identified as associated with the received voice trigger.

36. A system for inserting audio content into one or more communications channels, the system comprising:
means for associating audio content with one or more corresponding triggers;
means for establishing a communications channel with an initiating device and a host;
means for establishing a communications channel with a recipient device and the host;
means for enabling voice communications to be exchanged, through the host, between the initiating device and the recipient device; and
means for receiving, from the initiating device, an SMS message including a trigger to insert audio content;
means for identifying, based on the associated audio content with one or more corresponding triggers, the audio content associated with the received trigger;
means for accessing the audio content identified as associated with the received trigger;
means for inserting the accessed audio content in the communications channel with the initiating device and the host and the communications channel with the recipient device and the host.

37. A system for inserting audio content into one or more communications channels, the system comprising:
an associating module configured to associate audio content with one or more corresponding triggers;
a communications module configured to:
establish a communications channel with an initiating device and a host,
establish a communications channel with a recipient device and the host,
enable voice communications to be exchanged, through the host, between the initiating device and the recipient device, and
receive, from the initiating device, an SMS message including a trigger to insert audio content; and
a processing module configured to:
identify, based on the associated audio content with one or more corresponding triggers, the audio content associated with the received trigger,
access the audio content identified as associated with the received trigger, and
insert the accessed audio content in the communications channel with the initiating device and the host and the communications channel with the recipient device and the host.

38. A system for inserting audio content into one or more communications channels, the system comprising:
means for associating audio content with one or more corresponding triggers;
means for establishing a communications channel with an initiating device and a host;
means for establishing a communications channel with a recipient device and the host;
means for enabling voice communications to be exchanged, through the host, between the initiating device and the recipient device; and
means for receiving, from the initiating device, a dual tone multi-frequency (DTMF) indicative of a pressed key on the device keypad;
means for identifying, based on the associated audio content with one or more corresponding triggers, the audio content associated with the received DTMF;
means for accessing the audio content identified as associated with the received DTMF;
means for inserting the accessed audio content in the communications channel with the initiating device and the host and the communications channel with the recipient device and the host.

39. A system for inserting audio content into one or more communications channels, the system comprising:
an associating module configured to associate audio content with one or more corresponding triggers;
a communications module configured to:
establish a communications channel with an initiating device and a host,
establish a communications channel with a recipient device and the host,
enable voice communications to be exchanged, through the host, between the initiating device and the recipient device, and
receive, from the initiating device, a dual tone multi-frequency (DTMF) indicative of a pressed key on the device keypad; and
a processing module configured to:
identify, based on the associated audio content with one or more corresponding triggers, the audio content associated with the received DTMF,
access the audio content identified as associated with the received DTMF, and
enable insertion of the accessed audio content in the communications channel with the initiating device and the host and the communications channel with the recipient device and the host.

40. A system for inserting audio content into one or more communications channels, the system comprising:
means for associating audio content with one or more corresponding triggers;
means for establishing a communications channel with an initiating device and a host;
means for establishing a communications channel with a recipient device and the host;
means for enabling voice communications to be exchanged, through the host, between the initiating device and the recipient device;
means for receiving, from the initiating device, instructions including a trigger to insert audio content;
means for identifying, based on the associated audio content with one or more corresponding triggers, the audio content associated with the received trigger;
means for accessing the audio content identified as associated with the received trigger; and
means for inserting the accessed audio content in the communications channel with the initiating device and the host and the communications channel with the recipient device and the host.

41. A system for inserting audio content into one or more communications channels, the system comprising:
an associating module configured to associate audio content with one or more corresponding triggers;
a communications module configured to:
establish a communications channel with an initiating device and a host,
establish a communications channel with a recipient device and the host,
enable voice communications to be exchanged, through the host, between the initiating device and the recipient device, and
receive, from the initiating device, instructions including a trigger to insert audio content; and
a processing module configured to:
identify, based on the associated audio content with one or more corresponding triggers, the audio content associated with the received trigger,
access the audio content identified as associated with the received trigger, and
insert the accessed audio content in the communications channel with the initiating device and the host and the communications channel with the recipient device and the host.
